(19) United States
(12) Patent Application Publication
(10) Pub. No.: US 2003/0076200 A1
(43) Pub. Date: Apr. 24, 2003

(54) Filter cavity with corrugated wall

(76) Inventors: Slawomir J. Fiedziuszko, Palo Alto, CA (US); Torsten Schnabel, Mountain View, CA (US)

Correspondence Address: J.E. Kosinski, Loral Space & Communications, Ltd., Suite 303, 655 Deep Valley Drive, Rolling Hills Estates, CA, 90274, US

(21) Appl. No.: 10/027,826

(22) Filed: Oct. 18, 2001

(51) Int. Cl. H01P 1/20

(52) U.S. Cl. 333/202; 333/210; 333/212

(57) ABSTRACT

A filter includes an electromagnetic wave supporting structure having a cavity defined by an encircling sidewall, and microwave feeds coupled to the cavity for inputting and for outputting electromagnetic power to and from the wave supporting structure. At least a portion of an interior surface of the sidewall has a succession of corrugations. Successive ones of the corrugations are spaced apart by a distance less than approximately 0.2 wavelength of the electromagnetic wave, and each of the corrugations has a height greater than the spacing distance but less than approximately 0.5 wavelength of the electromagnetic wave. The geometry of the corrugated sidewall reduces interaction between the electromagnetic wave and the sidewall to inhibit dissipation of power of the electromagnetic wave within the sidewall.

### BACKGROUND OF THE INVENTION

This invention relates to construction of cavities for microwave filters, particularly dual mode cavity filters both with and without dielectric resonator loading, wherein improved performance in terms of reduced energy loss is obtained by a configuration of cavity wall with reduced interaction with electromagnetic waves within a cavity.

A filter, typically incorporating plural filter stages, is often employed in a communication system such as a microwave system communicating via satellite. Such filter stages may be constructed of only an air dielectric, or may include also a ceramic dielectric resonator for reduction in an overall size of the filter. In addition, such a filter stage may include tuning screws extending an adjustable amount into the cavity of the filter stage for tuning the filter stage and, furthermore, may include a mode coupling screw for conversion between a single mode and a dual mode of operation of the filter stage. The use of a dual mode filter is advantageous in that the characteristics of a higher order filter function can be obtained within a reduced number of filter stages, thereby providing a saving in overall physical size of the filter.

This is advantageous in the construction of a filter to have freedom of designing the filter with sharp skirts at the end of a filter pass band for optimal use of available spectrum for multiple communication channels. However, the sharpness of such skirts, as well as the implementation of other pass band characteristics which may require sharp resonance, are limited by propagation losses within the filter, a significant source of the lost power being the dissipation of microwave energy within the cavity walls of the filter. Therefore, improved performance of the filter, both in terms of the ability to attain a desired spectrum characteristic, as well as in its Q (quality factor), should be obtainable in a filter constructed in a manner which reduces the dissipation of microwave energy in the filter sidewalls. Existing filter construction does not provide for this feature.

### SUMMARY OF THE INVENTION

The aforementioned problems are overcome and other advantages are provided by a construction of the sidewall of a filter cavity, in accordance with the invention, wherein reduced interaction of electromagnetic waves with the cavity wall is obtained by introducing corrugations within the wall. Preferably, as viewed in a cross-sectional view of the wall, the corrugations have a rounded or sinuous form. The corrugations need be provided only on the inside of the sidewall. The distance between corrugations should be significantly less than the wavelength, preferably less than approximately 0.2 wavelength of the electromagnetic radiation resonant within the cavity. The height (or depth) of a corrugation is less than approximately 0.5 wavelength but is greater than the distance between the corrugations.

In the theory of operation of the invention, the corrugations, with the cross-sectional dimensions substantially smaller than a wavelength, may be likened to an electrically conductive wall with small holes therein. The holes have cross-sectional dimensions substantially less than a wavelength. In such an electromagnetic structure, there is little penetration of electromagnetic energy through the holes with the result that an electromagnetic wave interacting with the wall interacts with a reduced surface region of the wall. By way of example of such interaction, a component of the magnetic vector parallel to the surface of the wall may induce a surface current in the wall resulting in a power loss proportional to the product of the current and resistance of the wall. The presence of numerous small holes in the wall reduces the amount of wall surface available for interaction with the electromagnetic wave, with a consequent reduction in the amount of power loss. In similar fashion, the presence of the corrugations reduces the amount of surface current and the power loss associated therewith. Performance of the cavity of a stage of the filter is improved by the use of the corrugations, the performance being characterized by reduced power loss and insignificant generation of higher order modes of the electromagnetic waves within the filter stage.

### BRIEF DESCRIPTION OF THE DRAWING

The aforementioned aspects and other features of the invention are explained in the following description, taken in connection with the accompanying drawing figures wherein:

FIG. 1 shows a partially stylized view of a filter assembly having resonant cavities at least one of which has a corrugated sidewall constructed in accordance with the invention;

FIG. 2 is a set of three graphs showing operation of a group-delay equalizer in FIG. 1 in compensating for the delay in signals propagating through a set of cavity filter stages of a bandpass filter of FIG. 1;

FIG. 3 is a cross-sectional view of the group-delay equalizer taken along the line 3-3 FIG. 1, an arrangement of tuning screws within a cavity sidewall of FIG. 3 being representative of a corresponding arrangement of tuning screws in sidewalls of other cavities of FIG. 1 and of cavities in FIG. 4;

FIG. 4 is a side view of a further embodiment of a bandpass filter comprising two circular cavities arranged in series between two rectangular waveguides serving as input and output ports of the filter, the cavities having corrugated sidewalls in accordance with the invention;

FIG. 5 is a sectional view of an input waveguide taken along the line 5-5 of FIG. 4, and showing an iris coupling an input signal into a first of the cavities;

FIG. 6 is a fragmentary axial view of a cavity of FIG. 4 showing corrugations and a tuning screw, the showing of the corrugations being representative also of corrugations in a cavity of FIG. 1;

FIG. 7 is a fragmentary exploded view of a cavity of FIG. 4 showing connection of a circular iris plate to a flange of the cavity;

FIG. 8 is a view similar to FIG. 7 but showing an alternative configuration of cavity and iris plate having a rectangular cross-section;

FIG. 9 is a fragmentary view of cavity sidewall showing an embodiment wherein the thickness of a corrugation rib is greater than, or approximately equal to, a trough between two successive ribs of the corrugation; and

FIG. 10 is a view similar to that of FIG. 9, but showing corrugation wherein the thickness of a rib is less than the width of a trough of the corrugations of the sidewall.

Identically labeled elements appearing in different ones of the figures refer to the same element but may not be referenced in the description for all figures.

### DETAILED DESCRIPTION OF THE INVENTION

The invention applies to a filter comprising: a single cavity, as well as to multiple cavity filters, and applies also to a filter wherein the cavity is supporting only a single mode of electromagnetic wave as well as to a filter wherein the cavity is supporting plural modes of electromagnetic waves. In order to demonstrate the construction of the invention in a filter, or filter assembly, which is useful in a system for communication via satellite, FIGS. 1-3 show construction of a filter assembly 10 which, by way of example, comprises a bandpass filter 12 and a group-delay equalizer 14. As will be described in further detail in the ensuing description, microwave cavities are employed in the construction of the filter 12 and the equalizer 14, each of these cavities having the configuration of a right circular cylinder in a preferred embodiment of the invention, and wherein each of these cavities has an encircling sidewall which may include a corrugated inner surface for reduced interaction between an electromagnetic wave of the cavity and the encircling cavity wall.

While benefits of the invention can be obtained by placing the corrugations in only one of the foregoing cavities, a maximum benefit of the invention is obtained by placing the corrugations in all of the cavities. In any one of the cavities, a maximum benefit is obtained by forming the corrugated surface along and entire sidewall, however, a reduced benefit is available even if only a portion of the sidewall is formed with the corrugated surface. Also, as will be described in the ensuing description, the cavities may be provided with dielectric resonators, and also are provided with tuning screws and mode coupling screws to demonstrate utilization of the invention in a practical communication system. It is understood that the invention may be employed also in a simple cavity in which no resonator and no tuning screw are present.

As shown in FIG. 1, the bandpass filter 12 is constructed as an eight-pole filter; however, the filter may be constructed with some other number of poles such as six poles, if desired. An input microwave port 16 of the filter assembly 10 connects with the filter 12, and an output microwave port 18 of the filter assembly 10 connects with the equalizer 14 via a circulator 20. The circulator 20 is connected between the filter 12 and the equalizer 14 to couple electromagnetic signals between an output of the filter 12 and an input of the equalizer 14. Directions of signal flow are indicated by arrows. The filter 12 and the equalizer 14 are each constructed with at least one cavity having tuning elements, such as tuning screws disposed therein. The four cavities shown in the filter 12 provide for the eight-pole characteristic, and only three cavities would be required to provide for a six-pole characteristic. A single cavity is shown in the equalizer 14. The ceramic resonators shown in all of the cavities are useful in tuning the passband of the filter assembly 10 for the transmission of microwave signals, and also permit construction of the microwave cavities with a smaller physical size.

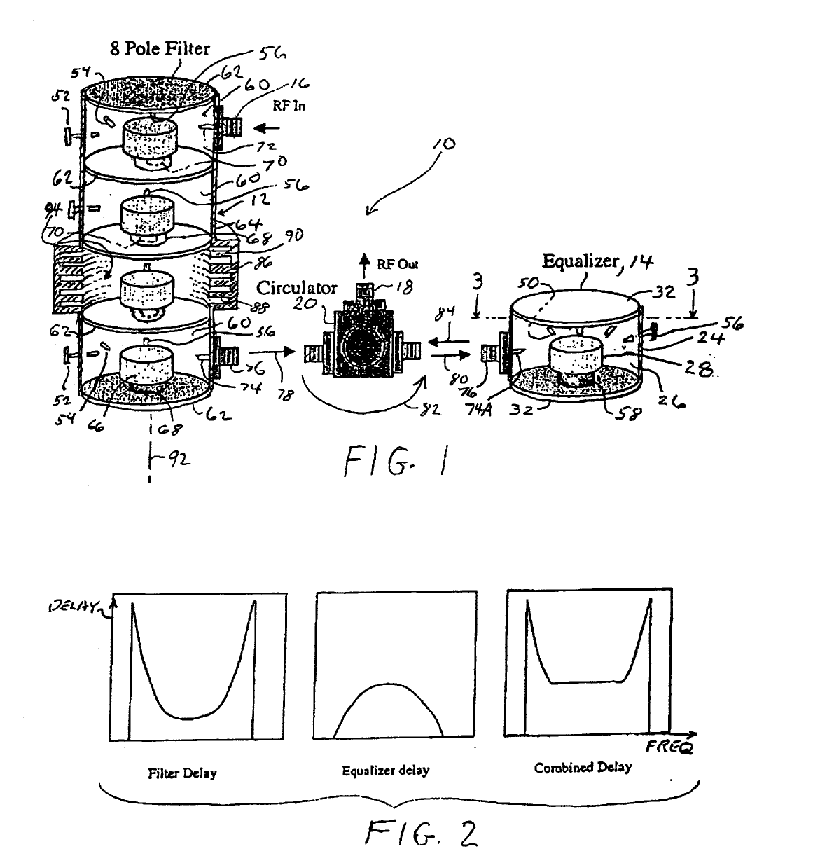

With reference to each of the three graphs of FIG. 2, group delay is shown on the vertical axis, and frequency is shown on the horizontal axis. The bandpass filter 12 introduces a group delay to signals passing through the filter 12, and the equalizer 14 tends to compensate for the group delay to overcome distortion in signal transmission associated with group delay. The graph on the left shows that the group delay of the bandpass filter 12 varies with frequency, and has maximum values of delay at both ends of the passband with a lesser amount of delay in the mid-band region. The middle graph shows that the equalizer introduces a group delay which varies with frequency such that a maximum amount of delay is introduced in the mid-band region, with lesser delay being introduced at both ends of the passband. The signal propagating through the filter assembly 10 (FIG. 1) experiences the contributions of the group delay of both the bandpass filter 12 and the equalizer 14, this resulting in the sum of the delays as is portrayed in the graph at the right of FIG. 2. The graph at the right shows that the equalizer 14 is operative to flatten the central portion of the filter passband, which portion is employed in the transmission of the signal through the filter assembly 10.

A similar form of construction may be utilized for the cavities of the bandpass filter 12 and for the cavity of the equalizer 14, the form of construction being demonstrated readily for the single cavity of the equalizer 14. With reference to FIGS. 1 and 3, the group-delay equalizer 14 is constructed of a housing 22 of an electrically conductive material such as copper or aluminum, and having an exterior wall 24 enclosing a right circular cylindrical cavity 26. A disk shaped ceramic resonator 28 is disposed along a central cylindrical axis 30 of the cavity 26. End walls 32 of the equalizer 14 connect with the wall 24 and close off the cavity 26, one of the end walls 32 serving to support and to locate the resonator 28 within the cavity 26. For ease of reference, the wall 24 may be described (with reference to the orientation of the equalizer shown in FIG. 3) as having an outer surface composed of a top surface 34, a bottom surface 36, a right surface 38 and a left surface 40 which are joined together by inclined surfaces 42 and 44 respectively at the left and the right edges of the top surface 36, and by inclined surfaces 46 and 48 respectively at the left and the right edges of the bottom surface 36. The inclined surfaces are inclined at 45 degrees relative to the top and the bottom surfaces.

Three tuning elements in the form of electrically conducting screws 52, 54, and 56 are shown disposed in the exterior wall 24, and being oriented with their respective axes intersecting the cylindrical axis 30. The screw 52 is located in the top surface 34, the screw 54 is located in the inclined surface 44, and the screw 56 is located in the right surface 38. By rotation of the screws 52, 54, and 56, respective ones of the screws can be advanced into the cavity 26 a desired amount for tuning the group-delay equalizer 14 for transmission of each of two orthogonal electromagnetic waves propagating within the equalizer 14. The tuning screw 52 interacts with the electric field of a vertically polarized one of the waves, and the tuning screw 56 interacts with the electric field of a horizontally polarized one of the waves. The tuning screw 54 is oriented at 45 degrees relative to the screws 52 and 56 for interaction with both of the waves to serve as a mode coupling screw for coupling electromagnetic energy between the two waves.

As shown in FIG. 1, in the equalizer 14, the resonator 28 is held at a predetermined distance from one of the end walls 32 by a supporting structure, which may be referred to as a pedestal 58, and is constructed of a cylindrical low-loss ceramic element secured by a suitable means, such as an adhesive, to an end surface of the resonator 28 and to the end wall 32. The resonator 28 is constructed of a ceramic disk in the shape of a right-circular cylinder wherein the ratio of the diameter of the disk to the thickness of the disk is greater than 2. The exterior wall 24 and the end wall 32 of the equalizer 14 may be fabricated of aluminum. The dielectric constant of the resonator 28 has a value typically in the range of 30-36. Most of the energy of the field is located within the resonator 28, and a relatively small amount of the energy is located within an evanescent mode within the cavity and outside of the resonator 28. The presence of the resonator 28 within the cavity 26 allows for the construction of a much smaller cavity for resonating at the desired frequency as compared to the physical size of such a cavity in the absence of the resonator. By way of example, the cavity of an equalizer which is dielectrically loaded with the ceramic resonator, as is the case with the equalizer 14 of the invention, is approximately ⅓ to ¼ the size of an unloaded cavity.

The foregoing construction of the equalizer 14 may be applied also in the construction of the bandpass filter 12. Thus, the bandpass filter 12, in the preferred embodiment of the invention, comprises four cavities 60 separated by end walls 62, with two additional end walls 62 located at opposite ends of the assembly of the filter 12, the assembly of the four cavities 60 being enclosed by an encircling cylindrical wall 64 which contacts the end walls 62. To reduce the overall size of the bandpass filter 12, it is advantageous to load the cavities 60 with dielectric resonators 66, the resonators 66 being positioned by pedestals 68 relative to respective ones of the end walls 62. The pedestals 68 are essentially transparent to the microwave radiation at the frequency of operation of the filter assembly 10, such as at a frequency of 12 Ghz (gigahertz) employed in the preferred embodiment of the invention. Accordingly, it is convenient to couple the cavities 60 by means of irises 70 located in respective ones of the end walls 62 beneath individual ones of the pedestals 68. The irises may be circular or cross shaped, by way of example, in accordance with the usual practice in construction of microwave filters.

The number of the poles of the filter 12 can be doubled by generation of two orthogonal modes of wave propagation within the filter 12. This can be accomplished by introducing the screws 52, 54 and 56, described above with reference to the construction of the equalizer 14, into the cavities 60 located at the ends of the filter 12, some of these screws being indicated in FIG. 1. For example, in the top cavity 60 of the filter 12, a screw 52 can interact with a microwave signal input by a probe 72 of the port 16 to generate a first mode of microwave propagation while interacting with screws 54 and 56 to introduce a second orthogonal mode of microwave propagation. Screws 52 and 56 in the other ones of the cavities 60 participate in the propagation of the two orthogonal modes. In the bottom cavity 60, the screw 54, mounted at the 45 degree angle position, enables coupling of microwave energy from both of the modes via the screw 52 to a probe 74 at a port 76 of the filter 12 for coupling, by a single mode, microwave signals between the filter 12 and the circulator 20. A similar port 76A with a probe 74A are located on the wall 24 of the equalizer 14 for coupling electromagnetic power into and out of the cavity 26 of the equalizer 14.

With respect to the operation of the circulator 20 (FIG. 1), the circulator 20 is a three-port circulator, wherein a first port connects with the filter port 76 to receive a signal, indicated at arrow 78, and a second port serves to output a signal, indicated at arrow 80, to the equalizer 14. The circulator 20 is constructed in well-known form such as a stripline structure with ferromagnetic material and an applied magnetic field to provide for a circulating propagation path indicated by arrow 82. Signals reflecting back from the equalizer 14 via its port 76A, indicated at arrow 84, output the circulator 20 at port 18. The equalizer cavity 26 resonates at the same frequency as does the bandpass filter 12, and thus the reflection causes a time delay only for those frequencies which are contained in the passband of the filter 12. Both the signals at arrows 80 and 84 are single mode signals, while the two orthogonal modes appear within the equalizer 14.

In accordance with the invention, the provision of a corrugated surface on the inner surface of the encircling wall 64 of a cavity 60 in the filter 12 is demonstrated in FIG. 1 for the case of the third cavity 60 wherein a thickened portion 86, of the wall 64 is provided with a set of the grooves or troughs 88 separated by ribs 90. The troughs 88 and the ribs 90 are parallel to the end walls 62 and perpendicular to a central cylindrical axis 92 of the filter 12. The succession of troughs 88 and ribs 90 provide for a corrugation 94 of an inner sidewall surface of the cavity 60.

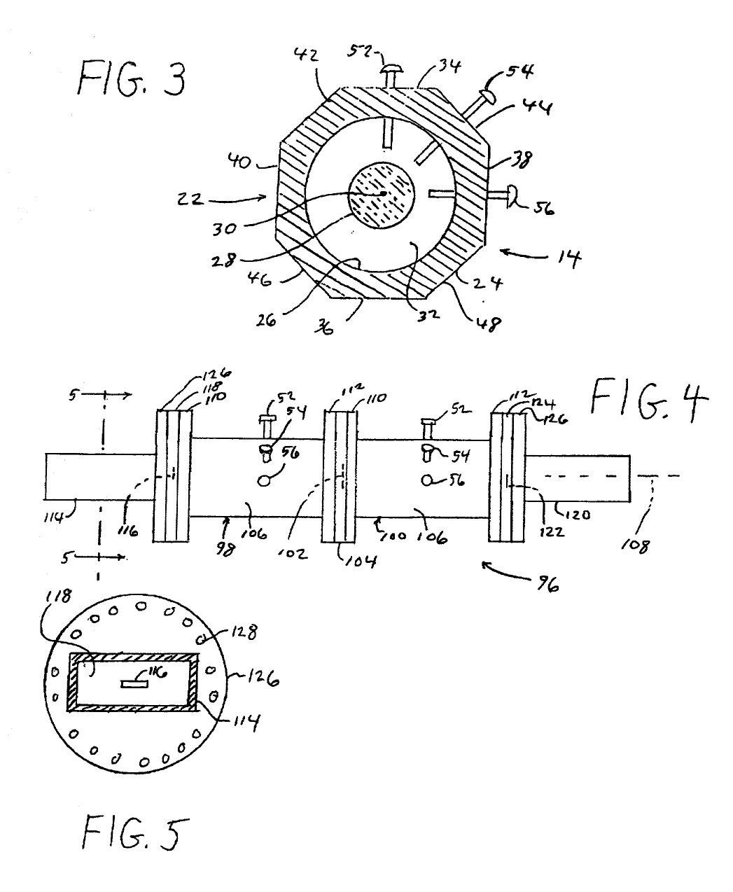

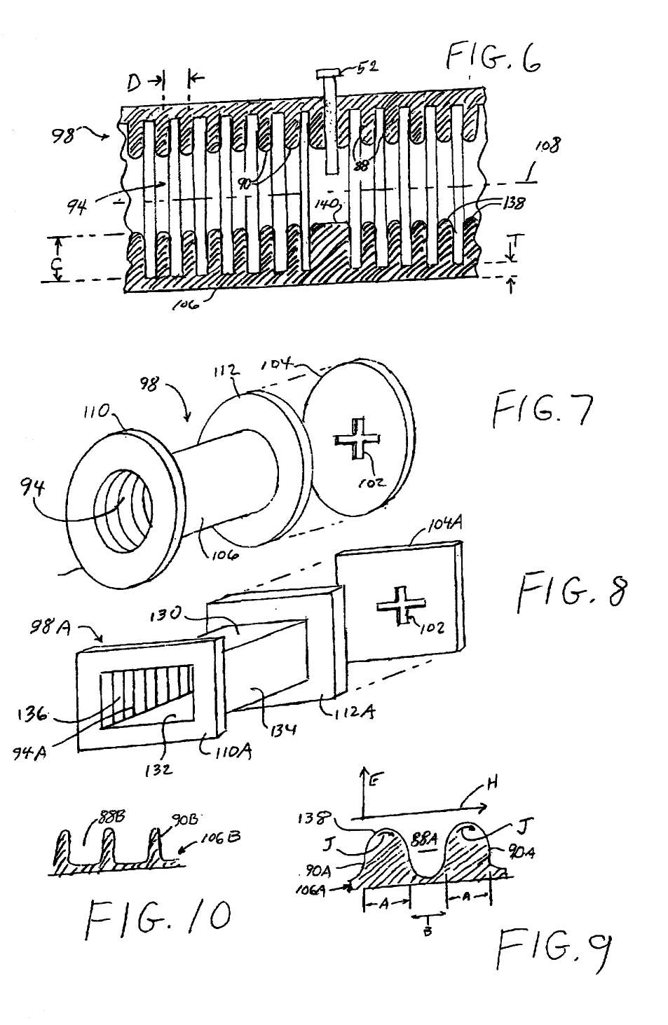

FIGS. 4-8 show a further embodiment of bandpass filter, indicated at 96, wherein the filter 96 comprises two cavities 98 and 100 arranged in series and coupled electromagnetically via an iris 102 centrally located in an iris plate 104 (shown also in FIG. 7). As a further example in the construction of the invention, the cavities 98 and 100 are provided without the ceramic resonators of FIG. 1. In FIGS. 4-8, the inner surface of each of the cavities 98 and 100 is bounded by a sidewall 106. Each of the cavities 98 and 100 includes the aforementioned set of tuning screws 52, 54 and 56 disposed in the sidewall 106 of the cavity, the operation of the tuning screws 52, 54 and 56 in the filter 96 being the same as that disclosed above with reference to the filter assembly 10 of FIG. 1. The sidewall 106 in each of the cavities 98 and 100 has the configuration of a right circular cylinder, wherein the outer surface of the sidewall 106 is smooth and the inner surface of the sidewall 106 is corrugated with corrugation 94 (shown in FIGS. 6 and 7). The cylindrical cavities 98 and 100 are disposed about a common cylindrical axis 108. In each of the cavities 98 and 100, opposite ends of the sidewall 106 terminates in flanges 110 and 112 which enable connection of the sidewall 106 to other components of the filter 96.

An input rectangular cross-sectional waveguide 114 couples electromagnetic signals into the first cavity 98 via an iris 116 centrally located in an iris plate 118, and an output rectangular cross-sectional waveguide 120 couples electromagnetic signals out of the second cavity 100 via an iris 122 centrally located in an iris plate 124. Each of the input and the output waveguides 114 and 120 have flanges 126 to enable connection of the waveguides to other components of the filter 96. Bolts 128 (shown in FIG. 5) pass through the flange 126 of the input waveguide 114 and through the iris plate 118 into the flange 110 of the first cavity 98 to secure the waveguide 114 and the iris plate 118 to the input end of the first cavity 98. In similar fashion, bolts (not shown) are employed to secure the flange 112 at the output end of the second cavity 100 via the iris plate 124 to the flange 126 of the output waveguide 120. Also, in similar fashion, bolts (not shown) are employed to secure the flange 112 of the first cavity 98 to the flange 110 of the second cavity 100 via the iris plate 104. The irises 116 and 122 are each configured as horizontal slots, and are parallel to each other and to the tuning screws 56 in each of the cavities 98 and 100. The iris 102 is configured as a crossed slot, wherein one portion of the slot is horizontal and parallel to the irises 116 and 122, and the other portion of the crossed slot is vertical and parallel to the tuning screw 52 in each of the cavities 98 and 100.

By way of alternative embodiments of the invention, is noted that the circular cylindrical cross-sectional form of the cavity 98 depicted in FIG. 7 may be replaced with an elliptical cross-sectional form (not shown), or a rectangular cross-sectional form, as depicted for a cavity 98A in FIG. 8. The cavity 98A comprises a top broad wall 130 and a bottom broad wall 132, which are joined together by a right sidewall 134 and a left sidewall 136. FIG. 8 demonstrates a further option for construction of the corrugation wherein a corrugation 94A is provided only on the two sidewalls 134 and 136 of the cavity 98A while the broad walls 130 and 132 remains smooth. The flanges 110A and 112A of the cavity 98A similarly have rectangular configuration for connection with iris plates, such as the iris plate 104A which connects to the flange 112A.

With reference to FIG. 6, which shows corrugation 94 suitable for use in a cavity of the filter assembly 10 (FIG. 1) as well as in the cavity 98 (FIG. 7) and in the cavity 98A (FIG. 8), the corrugation 94 may have different forms. By way of example, FIG. 6 depicts the corrugation 94 of FIG. 2, wherein tips 138 of the ribs 90 facing the axis 108 are rounded, as by a circular arc, and the sides of the troughs 88 are straight. The outer ends of the troughs 88, distant from the axis 108, may be flat, a shown in the sectional view of FIG. 6, or may be provided with a curvature (not shown). The corrugation may be formed either by a process of casting or machining. One of the ribs 90, further identified at 140, has a greater width than the width of the other ribs 90 in order to accommodate the width of a tuning screw such as the screw 52.

With reference to both FIGS. 1 and 4, the cavities are formed in a similar fashion. In FIG. 1, the end walls 62 in conjunction with the cylindrical wall 64 serve the function of defining the cavities 60 of the bandpass filter 12. The centrally located ones of the end walls 62 include the aforementioned irises 70 and, in this sense, may be regarded as iris plates such as the iris plates 104, 118 and 124 of FIG. 4. In FIG. 4, the iris plates 118 and 104 serve as end walls of the cavity 98, and the iris plates 104 and 124 serve as end walls of the cavity 100. While corrugations appear on the sidewalls of the cavities, no corrugations appear on the surfaces of the end walls, particularly on the surfaces of the iris plates which serve as the end walls. The iris plates must be thin, in terms of a wavelength of the electromagnetic radiation, to properly propagate electromagnetic signals through the irises between adjacent ones of the cavities.

It is noted that the corrugation 94, whether located in a cavity of the filter assembly 10 or in a cavity of the bandpass filter 96, must be rigid so as to have no effect on the tuning of the respective cavities such as might be produced by vibratory motion of a rib 90, in the event that equipment containing the cavities is subjected to vibration. Such vibratory motion may have the effect of introducing a low level noise spectrum located about a main spectral line to which a cavity is tuned. The thickened portion 86 of the cylindrical wall 64 of the bandpass filter 12 serves as a rigid base for supporting the ribs 90 and inhibiting any movement among the ribs 90 relative to each other and relative to an end wall 62. Also, the ribs 90 are constructed in solid form, as shown in FIGS. 6, 9 and 10 to provide a rigid interconnection with the thickened portion. In the embodiment of the filter 96 of FIGS. 4-8, the sidewall 106 is constructed with sufficient rigidity to inhibit vibratory movement among the ribs relative to each other and to the iris plates. For example, the rigidity may be provided by sufficient wall thickness, indicated at T in FIG. 6.

FIG. 9 shows a sidewall 106A which is similar in construction to the sidewall 106 of FIG. 6, but differs therefrom in that, in the embodiment of FIG. 9, ribs 90A have curved sides rather than the straight sides depicted in FIG. 6 for the ribs 90. Similarly, the sidewall of a trough 88A of FIG. 9 is curved. FIG. 9 depicts the situation wherein the width of a rib 90A (indicated at A) is equal to or somewhat greater than the width of the trough 88A (indicated at B). A sidewall 106B depicted in FIG. 10 is similar in construction to the sidewall 106A of FIG. 9 but differs therefrom in that the width of a rib 90B (FIG. 10) of the wall 106B is less than the width of a trough 88B of the wall 106B. The configuration of sidewall depicted in either FIG. 9 or FIG. 10 may be employed in waveguides configured with circular or rectangular configurations such as depicted in FIGS. 7 and 8.

The depth of the trough 88 (indicated at C in FIG. 6) is greater than the spacing between ribs 90 (indicated at D). The distance D between the ribs 90, should be significantly less than the wavelength of the electromagnetic radiation resonant within a cavity such as the cavity 98, preferably less than approximately 0.2 wavelength of the electromagnetic radiation resonant in the cavity. The height (or depth) C of the trough 88 is less than approximately 0.5 wavelength but is greater than the distance D between the ribs.

With respect to the theory of operation of the invention, FIG. 9 shows a graphical representation of the electromagnetic field which is shown to have an electric component (E) and a magnetic component (H), the latter being parallel to the wall 106A. There is interaction of the magnetic component (H) with the region at the tip 138 of a rib 9OA to produce surface current J. The surface current is produced only at the region of the tip 138 of which the surface is substantially parallel to the direction of the H vector. There is essentially no interaction of the surface of the steep slopes of the trough 88A with the magnetic component (H). As a result of the production of the surface current, there is resistive loss associated with the flow of the electric current in the electrically conductive maternal of the ribs 90A with a corresponding loss of power from the electromagnetic wave. Since only a relatively small portion of the corrugated sidewall 106A interacts with the magnetic component of the electromagnetic wave, as compared to a much larger interaction region in the case of a flat wall or a corrugated wall having flat tops to the ribs, the corrugated sidewall of the invention provides for a more efficient transfer and reduced loss of electromagnetic power. The relatively small spacing D between the ribs of the corrugation enables the electromagnetic characteristics of the corrugated sidewall to approach that of a flat-surface wall with respect to the construction of a resonant chamber, thereby to preserve the mode of resonance within the cavity.

It is to be understood that the above described embodiments of the invention are illustrative only, and that modifications thereof may occur to those skilled in the art. Accordingly, this invention is not to be regarded as limited to the embodiments disclosed herein, but is to be limited only as defined by the appended claims.

What is claimed is:

1. A filter comprising:
an electromagnetic wave supporting structure including a cavity defined by a rigid encircling sidewall, and means coupled to the cavity for inputting and for outputting electromagnetic power to and from the wave supporting structure; and
at least a portion of an interior surface of said sidewall has a succession of corrugations to inhibit loss of power from the electromagnetic wave, wherein successive ones of said corrugations are spaced apart by a distance less than approximately 0.2 wavelength of the electromagnetic wave, and each of the corrugations has a height greater than said distance but less than approximately 0.5 wavelength of the electromagnetic wave.

2. A filter according to claim 1, wherein each corrugation of the succession of corrugations has a curved surface facing a central portion of the cavity.

3. A filter according to claim 1, wherein the wave supporting structure supports a first wave propagating in a first mode and a second wave propagating in a second mode, the filter further comprising a first of tuning element positioned to interact with the first wave, a second tuning element positioned to interact with the second wave, and a third tuning element positioned for coupling electromagnetic energy between the first wave and the second wave.

4. A filter according to claim 3, wherein said wave supporting structure further comprises a resonator located in said cavity, said resonator being a ceramic resonator.

5. A filter according to claim 4, wherein said resonator is a ceramic resonator located on a central axis of said cavity, and each of said tuning elements is directed toward said central axis.

6. A filter according to claim 1, wherein said wave supporting structure further comprises a resonator located in said cavity, said resonator being a ceramic resonator.

7. A filter according to claim 6, wherein said resonator is a ceramic resonator located on a central axis of said cavity, and each of said tuning elements is directed toward said central axis.

8. A filter according to claim 1, further comprising a first tuning screw, a second tuning screw and a third tuning screw extending through said sidewall into said cavity, and wherein, in said wave supporting structure, two of said tuning screws support two orthogonal modes of the electromagnetic waves, and a third of said tuning screws is a mode coupling screw angled relative to said first two screws.

9. A filter according to claim 1, wherein said cavity is a cylindrical cavity, and said corrugations encircle a central axis of the cavity.

10. A filter according to claim 1, wherein said sidewall of said cavity comprises a plurality of flat wall sections disposed about a central axis of the cavity, and wherein an interior surface of at least one of said flat wall sections is corrugated.

11. A filter according to claim 1 further comprising opposed end walls interconnecting with said sidewall to define said cavity, wherein interior surfaces of said end walls are free of said corrugations.

12. A filter according to claim 1 wherein the corrugations disposed on the interior surface of the sidewall are machined grooves.

13. A filter according to claim 1 wherein the corrugations have uniform dimensions.

14. A filter according to claim 1 wherein the corrugations vary in their dimensions.

15. A filter according to claim 1 wherein a portion of each corrugation nearest to a central axis of the cavity has a generally sinusoidal shape.

16. A filter according to claim 1 wherein a portion of each corrugation nearest to a central axis of the cavity has a generally circular shape.

17. A filter according to claim 1 wherein the sidewall comprises an electrically conductive material, and ribs of the corrugations extend in circular fashion encircling a central axis of the cavity.

18. A filter according to claim 1 wherein the sidewall has a generally rectangular cross section.

19. A filter according to claim 18 wherein ribs of the corrugations are located on at least one surface of the sidewall.

20. A filter according to claim 1 wherein a thickness of a rib of the succession of corrugations is greater than a width of a trough between adjacent ribs of the succession of corrugations.

21. A filter according to claim 1 wherein a thickness of a rib of the corrugations is less than a width of a trough between adjacent ribs of the corrugation.

22. A filter according to claim 1 wherein a thickness of a rib of the succession of corrugations is equal to a width of a trough between adjacent ribs of the succession of corrugations.

23. A filter according to claim 1 wherein said cavity is a first cavity, said wave supporting structure further comprising a second cavity and an iris plate disposed between said first and said second cavities to serve as an end wall for each of said first and said second cavities, an iris of said iris plate coupling electromagnetic energy between said first and said second cavity, said sidewall serving to define also said second cavity, said filter further comprising a first tuning screw, a second tuning screw and a third tuning screw extending through said sidewall into said first cavity, and wherein, in said wave supporting structure, two of said tuning screws support two orthogonal modes of the electromagnetic waves, and a third of said tuning screws is a mode coupling screw angled relative to said first two screws.

24. A filter according to claim 23 further comprising a ceramic resonator located in said first cavity.

25. A filter according to claim 23 further comprising ceramic resonators located in respective ones of said cavities.

26. A filter according to claim 23 wherein each of said inputting means and said outputting means comprises a waveguide and an iris plate, the iris plate of said inputting means serving as an end wall of said first cavity for enabling an inputting of electromagnetic energy into said first cavity via an iris of said iris plate of said inputting means, and the iris plate of said outputting means serving as an end wall of said second cavity for enabling an outputting of electromagnetic energy from said first cavity via an iris of said iris plate of said outputting means.

27. A filter according to claim 26 wherein in each of said iris plates, surfaces of the iris plates are free of said corrugations.
